(19) United States
(12) Patent Application Publication
(10) Pub. No.: US 2024/0314813 A1
(43) Pub. Date: Sep. 19, 2024

(54) SEED BASED RESOURCE ALLOCATION AND COLLISION AVOIDANCE IN NR SIDELINK MODE 2

(71) Applicant: Nokia Technologies Oy, Espoo (FI)

(72) Inventors: Berthold PANZNER, Munich (DE); Stepan KUCERA, Munich (DE); Daniel MEDINA, Munich (DE)

(21) Appl. No.: 18/681,235

(22) PCT Filed: Jun. 7, 2022
(86) PCT No.: PCT/FI2022/050392

§ 371 Date: Feb. 5, 2024

Related U.S. Application Data
(60) Provisional application No. 63/230,881, filed on Aug. 9, 2021.

(51) Int. Cl. H04W 72/25; H04L 5/00

(52) U.S. Cl. CPC H04W 72/25; H04L 5/0007

(57) ABSTRACT

Methods, apparatuses, and non-transitory computer-readable medium products for seed based resource allocation and collision avoidance in slidelink are provided. A method comprising: receiving, with a first device from a sidelink device, an indication of use of a pattern of transmission associated with the sidelink device; determining, based on the indication, a resource allocation for the first device; and performing transmission with the determined resource allocation.

### TECHNICAL FIELD

The example and non-limiting embodiments relate generally to sidelink communication and, more particularly, to allocation of sidelink resources without support from the serving gNB.

### BACKGROUND

It is known, in blind resource allocation, to perform extensive sensing and/or inter-UE coordination.

### SUMMARY

The following summary is merely intended to be illustrative. The summary is not intended to limit the scope of the claims.

In accordance with one aspect, an apparatus comprising: at least one processor; and at least one non-transitory memory including computer program code; the at least one memory and the computer program code configured to, with the at least one processor, cause the apparatus at least to: receive, from a sidelink device, an indication of use of a pattern of transmission associated with the sidelink device; determine, based on the indication, a resource allocation for the apparatus; and perform transmission with the determined resource allocation.

In accordance with one aspect, a method comprising: receiving, with a first device from a sidelink device, an indication of use of a pattern of transmission associated with the sidelink device; determining, based on the indication, a resource allocation for the first device; and performing transmission with the determined resource allocation.

In accordance with one aspect, an apparatus comprising means for performing: receiving, from a sidelink device, an indication of use of a pattern of transmission associated with the sidelink device; determining, based on the indication, a resource allocation for the apparatus; and transmitting with the determined resource allocation.

In accordance with one aspect, a non-transitory computer-readable medium comprising program instructions stored thereon which, when executed with at least one processor, cause the at least one processor to: receive, with a first device from a sidelink device, an indication of use of a pattern of transmission associated with the sidelink device; determine, based on the indication, a resource allocation for the first device; and perform transmission with the determined resource allocation.

In accordance with one aspect, an apparatus comprising: at least one processor; and at least one non-transitory memory including computer program code; the at least one memory and the computer program code configured to, with the at least one processor, cause the apparatus at least to: determine a pattern of transmission associated with the apparatus; and indicate the determined pattern of transmission to at least one sidelink device.

In accordance with one aspect, a method comprising: determining a pattern of transmission associated with a first device; and indicating the determined pattern of transmission to at least one sidelink device.

In accordance with one aspect, an apparatus comprising means for performing: determining a pattern of transmission associated with the apparatus; and indicating the determined pattern of transmission to at least one sidelink device.

In accordance with one aspect, a non-transitory computer-readable medium comprising program instructions stored thereon which, when executed with at least one processor, cause the at least one processor to: determine a pattern of transmission associated with a first device; and indicate the determined pattern of transmission to at least one sidelink device.

In accordance with one aspect, a computer program comprising instructions stored thereon for performing at least the following: receiving, with a first device from a sidelink device, an indication of use of a pattern of transmission associated with the sidelink device; determining, based on the indication, a resource allocation for the first device; and performing transmission with the determined resource allocation.

In accordance with one aspect, a computer program comprising instructions stored thereon for performing at least the following: determining a pattern of transmission associated with a first device; and indicating the determined pattern of transmission to at least one sidelink device.

### BRIEF DESCRIPTION OF THE DRAWINGS

The foregoing aspects and other features are explained in the following description, taken in connection with the accompanying drawings, wherein:

FIG. 1 is a block diagram of one possible and non-limiting example system in which the example embodiments may be practiced;

FIG. 2 is a diagram illustrating features as described herein;

FIG. 3 is a diagram illustrating features as described herein;

FIG. 4 is a flowchart illustrating steps as described herein; and

FIG. 5 is a diagram illustrating features as described herein.

### DETAILED DESCRIPTION OF EMBODIMENTS

The following abbreviations that may be found in the specification and/or the drawing figures are defined as follows:
3GPP third generation partnership project
5G fifth generation
5GC 5G core network
ACK acknowledgment
AMF access and mobility management function
CSI channel state information
CU central unit
DFN direct frame number
DRX discontinuous reception (power saving mode)
DU distributed unit
eNB (or eNodeB) evolved Node B (e.g. an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, i.e., the LTE radio access technology
gNB (or gNodeB) base station for 5G/NR, i.e., a node providing NR user plane and control plane protocol terminations towards the UE, and connected via the NG interface to the 5GC
HARQ hybrid automatic repeat request
I/F interface
IMSI international mobile subscriber identity
InC in-coverage flag (e.g. in-coverage indicator bit in PSBCH payload: UE is within network coverage)
L1 layer 1
LSB least significant bit
LTE long term evolution
MAC medium access control
MCS modulation and coding scheme
MIB-SL sidelink master information block
MME mobility management entity
NACK negative acknowledgment
NAI network access identifier
ng or NG new generation
ng-eNB or NG-eNB new generation eNB
NR new radio
N/W or NW network
PCP pattern configuration parameter
PDCP packet data convergence protocol
PHY physical layer
PID pattern identifier
PSBCH physical sidelink broadcast channel
PSCCH physical sidelink control channel
PSFCH physical sidelink feedback channel
PSSCH physical sidelink shared channel
RAN radio access network
RB resource block
RF radio frequency
RLC radio link control
RP resource pool
RRC radio resource control
RRH remote radio head
RS reference signal
RU radio unit
Rx receiver
SCI sidelink control information
SDAP service data adaptation protocol
SFN system frame number
SGW serving gateway
SIB system information block
SL sidelink
SL-MIB sidelink master information block
SMF session management function
S-PSS sidelink primary synchronization signal
S-SSID sidelink synchronization source ID (e.g. 0 . . . 671)
S-SSS sidelink secondary synchronization signal
SUCI subscription concealed identifier
SUPI subscription identifier (e.g. IMSI, NAI)
TB transport block
Tx transmitter
UE user equipment (e.g. a wireless, typically mobile device)
UPF user plane function
V2X vehicle-to-everything

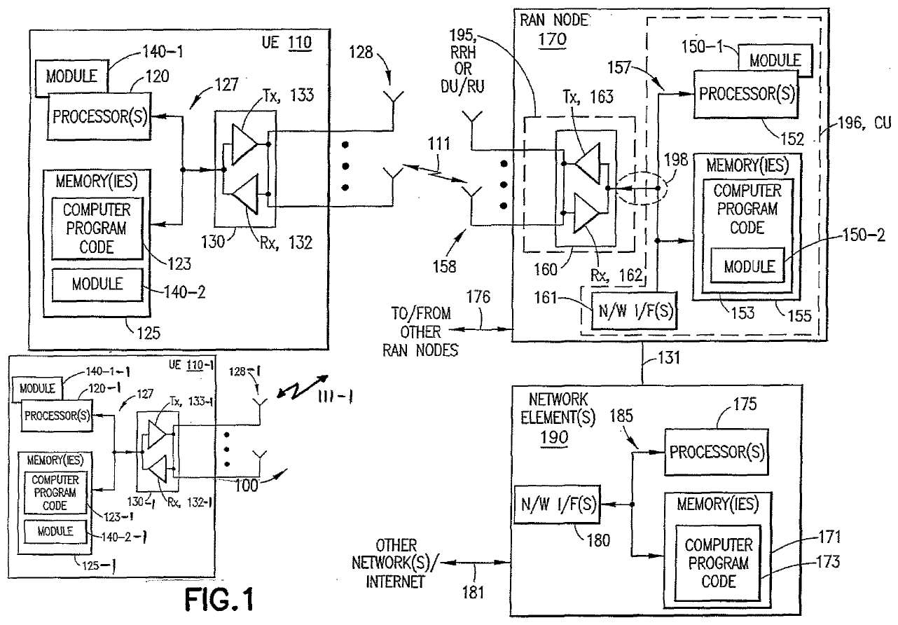

Turning to FIG. 1, this figure shows a block diagram of one possible and non-limiting example in which the examples may be practiced. A user equipment (UE) 110, radio access network (RAN) node 170, and network element(s) 190 are illustrated. In the example of FIG. 1, the user equipment (UE) wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

Optionally, the UE 110 may also communicate with other UEs via short range communication technologies, such as Bluetooth®. If wireless communication with a network is unavailable or not possible, or in addition to network communication, the UE 110 may be capable of sidelink communication with other UEs. For example, the UE 110 may perform sidelink communication with a UE 110-1. Duplicative description of UE 110-1 is omitted.

The RAN node 170 in this example is a base station that provides access by wireless devices such as the UE 110 to the wireless network 100. The RAN node 170 may be, for example, a base station for 5G, also called New Radio (NR). In 5G, the RAN node 170 may be a NG-RAN node, which is defined as either a gNB or a ng-eNB. A gNB is a node providing NR user plane and control plane protocol terminations towards the UE, and connected via the NG interface to a 5GC (such as, for example, the network element(s) 190). The ng-eNB is a node providing E-UTRA user plane and control plane protocol terminations towards the UE, and connected via the NG interface to the 5GC. The NG-RAN node may include multiple gNBs, which may also include a central unit (CU) (gNB-CU) 196 and distributed unit(s) (DUs) (gNB-DUs), of which DU 195 is shown. Note that the DU may include or be coupled to and control a radio unit (RU). The gNB-CU is a logical node hosting RRC, SDAP and

PDCP protocols of the gNB or RRC and PDCP protocols of the en-gNB that controls the operation of one or more gNB-DUs. The gNB-CU terminates the F1 interface connected with the gNB-DU. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU is a logical node hosting RLC, MAC and PHY layers of the gNB or en-gNB, and its operation is partly controlled by gNB-CU. One gNB-CU supports one or multiple cells. One cell is supported by only one gNB-DU. The gNB-DU terminates the F1 interface 198 connected with the gNB-CU. Note that the DU 195 is considered to include the transceiver 160, e.g. as part of a RU, but some examples of this may have the transceiver 160 as part of a separate RU, e.g. under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g. link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU, and the one or more buses 157 could be implemented in part as, for example, fiber optic cable or other suitable network connection to connect the other elements (e.g. a central unit (CU), gNB-CU) of the RAN node 170 to the RRH/DU 195. Reference 198 also indicates those suitable network link(s).

It is noted that description herein indicates that “cells” perform functions, but it should be clear that equipment which forms the cell will perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree Cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g. the Internet). Such core network functionality for 5G may include access and mobility management function(s) (AMF(s)) and/or user plane functions (UPF(s)) and/or session management function(s) (SMF(s)). Such core network functionality for LTE may include MME (Mobility Management Entity)/SGW (Serving Gateway) functionality. These are merely illustrative functions that may be supported by the network element(s) 190, and note that both 5G and LTE functions might be supported. The RAN node 170 is coupled via a link 131 to a network element 190. The link 131 may be implemented as, e.g., an NG interface for 5G, or an SI interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. The one or more memories 171 and the computer program code 173 are configured to, with the one or more processors 175, cause the network element 190 to perform one or more operations.

The wireless network 100 may implement network virtualization, which is the process of combining hardware and software network resources and network functionality into a single, software-based administrative entity, a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, and other functions as described herein.

In general, the various embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, tablets with wireless communication capabilities, as well as portable units or terminals that incorporate combinations of such functions. In addition, various embodiments of the user equipment 110 can include, but are not limited to, devices integrated into vehicles, infrastructure associated with vehicular travel, wearable devices used by pedestrians or other non-vehicular users of roads, user equipment unrelated to traffic users, and user equipment configured to participate in sidelink scenarios, such as public safety user equipment and/or other commercial user equipment.

Features as described herein generally relate to, while not being limited to, new radio (NR) sidelink (SL) communications. NR SL methods may be implemented to provide communication between user equipments, a vehicle and a network, infrastructure(s), other vehicle(s), or other road user(s) in the surrounding/immediate area. Such communication may enable proximity service (ProSe), or transmission of information about the surrounding environment, between devices in close proximity, for example device-to-device (D2D) communication technology. Such direct communication may be available even when network coverage is unavailable. Additionally or alternatively, NR SL methods may be implemented in scenarios unrelated to traffic users, such as public safety scenarios and/or commercial scenarios. Enhancements to sidelink procedures may be applicable in these vehicle-to-everything (V2X) and other use cases. Sidelink procedures may include groupcast, unicast, multicast, and/or broadcast procedures.

Features as described herein generally relate to sidelink resource allocation in mode 2, under which sidelink UEs must autonomously allocate/coordinate sidelink transmission resources without support from a serving gNB. TSG RAN1 and RAN2 address “Resource Allocation enhancements for Mode 2” as part of 3GPP Rel-17 WI NR_SL_enh-Core (RP-202846). In SL resource allocation mode 1, the network/network node/base station, e.g., NG-RAN, schedules SL transmission resource(s) for SL UE(s). In SL resource allocation mode 2, an SL UE autonomously selects SL transmission resources from a pool of resources. In mode 2, the UE may perform a sensing procedure in order to receive the resource reservation information of other nearby UEs from their transmitted SCIs. Afterwards, the UE may select resource(s) for transmission based on the outcome of the sensing procedure. NR SL mode 2 resource allocation may be based on full sensing, partial sensing, or random (resource) selection (i.e. no sensing).

In NR SL, the SL control information (SCI) indicates the resource and other transmission parameters used by a SL Tx UE for transmitting transport block (TB) of SL data and other control information, such as CSI report. The SCI consists of two parts. In the 1st stage SCI, transmitted/received on PSCCH, resource allocation and modulation and coding scheme (MCS) related information is carried. This information is also used for sensing in mode 2 resource allocation. In the 2nd stage SCI, transmitted/received on PSSCH, hybrid automatic repeat request(s) (HARQ) and SL L2 IDs related information is carried. In NR SL, the sensing based mode 2 resource allocation relies on continuously monitoring and receiving at least 1st stage SCI transmitted over PSCCH. The sensing history within the sensing window (e.g. 100 ms or 1100 ms as specified in TR 37.985) is used for the resource selection at an individual UE in mode 2.

Optimally, sidelink transmission resources may be allocated: quickly by multiple sidelink UEs in parallel; reliably, without any overlaps (transmission collisions or interference); and/or efficiently without extensive inter-UE coordination (as currently discussed by RAN1 with the UE-A/UE-B model). These objectives may be difficult to achieve in UEs that transition from RRC IDLE/RRC INACTIVE mode to RRC CONNECTED mode or UEs that enter sidelink communication and so, by definition, could not monitor past transmission(s) and grant(s) for future transmissions.

Blind resource allocation may occur where the UE may not be able to monitor past transmission(s) and grant(s) for future transmissions. Extensive sensing and/or inter-UE coordination may be used to perform blind resource allocation. In extensive sensing, RAN2 specification permits to sense between 100 and 1100 ms to determine used resources, which may result in significant delay. Pre-transmission checks may lead to the cancellation of a transmission even after this sensing period. In inter-UE coordination, in RAN1, there may be control-signaling exchange between sidelink UEs, where the TX-UE may request that the (intended) receiving UE propose suitable SL resources (whether preferred or non-preferred SL resources) for the SL transmission from the requesting UE to its peer UE. By delegating other UEs to perform sensing on behalf of inactive UEs, the sensing delay may be eliminated, but other problems around signaling complexity, candidate UE detection and selection, as well as questions around delegation UE capability, availability and reliability (e.g. quantization and limited feedback), may arise. The delay benefit may be negated by extended signaling (e.g. contradictory messages).

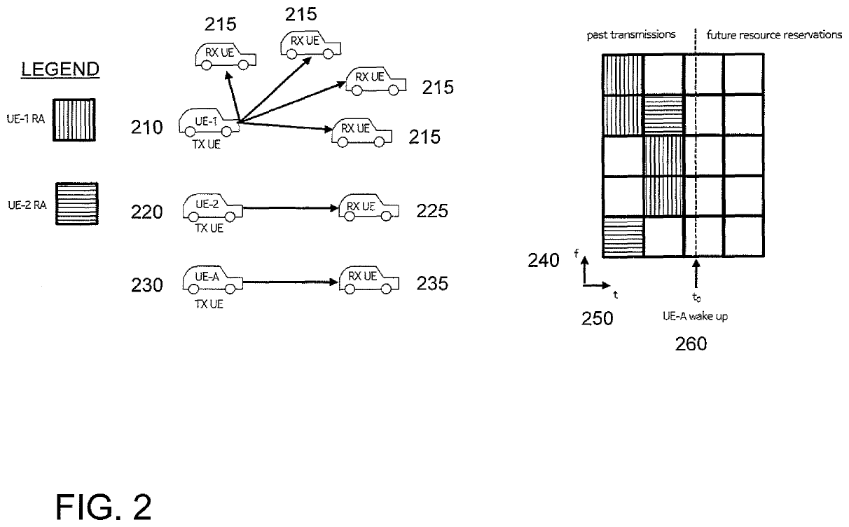

Referring now to FIG. 2, illustrated is an example in which UE-1 (210) and UE-2 (220) are performing transmission before UE-A (230) becomes activated, or comes into the scenario, at time to (260) in order to transmit sidelink data. UE-A (230) may not consciously control inter-UE interference unless it (instantaneously) acquires the knowledge of SL resources that are/will be in use by surrounding sidelink UEs, i.e. namely the groupcast transmitter UE-1 (210) and the unicast transmitter UE-2 (220).

In the example of FIG. 2, UE-1 (210) may perform groupcast transmission to multiple RX UEs (215); UE-2 (220) may perform unicast transmission to a single RX UE (225); and UE-A (230) may intend to perform transmission to RX UE (235). It may be noted that FIG. 2 illustrates a non-limiting example; in another example, the TX UEs may perform, alternatively or additionally, reception, perform different types of (sidelink) communication, and/or may present a different configuration of TX UEs and RX UEs (e.g. different number of TX UEs, different number of RX UEs, transmission to the same or different RX UEs, etc.).

Referring now to FIG. 2, the time instance to may be such that the UE-A (230) may miss the 1st stage SCI carried by physical sidelink control channel (PSCCH) transmission in the first 2 or 3 symbols, even in the current PSCCH slot of UE-1 (210) and/or UE-2 (220). This may mean that the reservation of up to 3 SL resource (s) (i.e. resource allocation) in the 1st stage SCI transmission (s) by UE-1 (210) and/or UE-2 (220) may be missed by UE-A (230). Hence, UE-A (230) may not know immediately, at time instance t0, which sidelink resources are in use by other UEs (i.e. blocked for UE-A (230)) and which sidelink resources are available for UE-A (230). This may be due to the UE-A (230) not being aware, at time to, of past transmission(s) and SCI grant(s) reserving resources for future transmissions by the groupcast UE-1 (210) and unicast UE-2 (220) and missing the resource allocation information included in SCI. Consequently, UE-A (230) may not determine future interference-free resources without extensive passive sensing and/or active inter-UE coordination. In other words, when UE-A (230) first wakes up at time to, there may be a period of time during which the UE-A (230) does not have sufficient information to determine which resources are available for UE-A's sidelink communication, and may therefore not be able to perform quick and/or efficient allocation of resources.

Before UE-A (230) wakes up at time t0 (260), UE-1 (210) and UE-2 (220) may, for example, have performed transmission over two blocks of time along the x axis (250) and five blocks of frequency along the y axis (240). Of ten time-frequency blocks, three may have been allocated to/used by UE-1 (210) and three may have been allocated to/used by UE-2 (220). At the time UE-A (230) wakes up (260), UE-A (230) may be unable to determine the availability of a time-frequency block for r transmission due to a lack of information regarding previous transmission associated with UE-1 (210) and/or UE-2 (220), and/or failing to receive first stage SCI; future resource reservations may be unknown to UE-A (230).

A technical effect of example embodiments of the present disclosure may be to allow sidelink UEs to quickly, efficiently and/or reliably determine the allocation of future SL resources in NR sidelink mode 2 without the need of (extensive) sensing and without the need of inter-UE coordination.

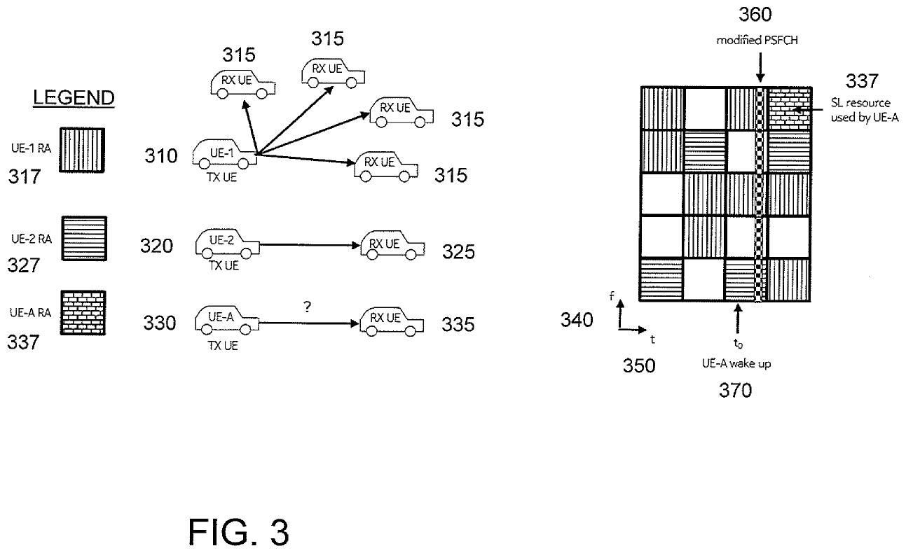

Referring now to FIG. 3, illustrated is an example scenario in which TX UEs are transmitting according to example embodiment(s) of the present disclosure. UE-1 (310) may perform groupcast SL transmission to RX UEs 315 according to the time-frequency resource blocks 317. UE-2 (320) may perform unicast SL transmission to RX UE 325 according to the time-frequency resource blocks 327. UE-A (330) may intend to perform SL transmission to RX UE (335). UE-A (330) may wake up at time to (370), such that it does not have knowledge/information regarding past transmissions of other (neighboring) UEs performing sidelink transmission. After waking up at time to (370), the UE-A (330) may detect a modified PSFCH (360). Based on this modified PSFCH (360), the UE-A (330) may be able to determine the transmission pattern of UE-1 (310) and/or UE-2 (320). Accordingly, UE-A (330) may be able to determine a SL resource available for transmission, such resource as 337. Alternatively, based on this modified PSFCH (360), the UE-A (330) may be able to determine one or more SL resources that are unused, and choose at least one of these unused resources for transmission.

The example of FIG. 3 is non-limiting; other example embodiments of the present disclosure may be applied in the illustrated scenario. For example, the UE-A (330) may detect a modified SCI or SIB rather than a modified PSFCH, as illustrated in the figure.

In an example embodiment, sidelink UEs may allocate sidelink transmission resources in mode 2 based on pre-defined patterns or sequences of time-frequency resource blocks (e.g. periodic and/or pseudo-random patterns) whose properties may be controlled by so-called pattern configuration parameters (PCP) (e.g. L1/L2 ID of the source UE (i.e. TX-UE), the seed value of a pseudo-random patterns, offset/periodicity for periodic patterns, parts/subsets of one or more of the foregoing example PCPs, etc.). A seed may be an initial number/value used to define a pseudo-random number/pattern. In an example embodiment, a (pre-defined) pattern/sequence may be represented by a pattern identifier (PID), which may allow identification of a pattern (e.g. uniquely or with bounded probability of error) based on its PCP (e.g. PID may be equal to the seed or part/subset of a seed of a pseudo-random pattern, or PID may be defined as a hash value for multiple PCPs). In an example embodiment, UE sidelink transmissions may be publicly associated with PIDs (e.g. PID may be indicated explicitly within SCI or physical sidelink feedback channel (PSFCH), or may be indicated implicitly via SIB) such that by overhearing/detecting/decoding a transmission (or just a part of it), a pattern may be determined by a newly joined/activated UE.

In an example embodiment, a sidelink UE itself (e.g. after transitioning to RRC CONNECTED mode, or after entering sidelink communication, or after coming into a sidelink scenario) or an assisting UE (e.g. UE-A (230) monitoring on behalf of other UEs in RRC_IDLE/RRC_INACTIVE) may identify the underlying sidelink resource allocation pattern(s) (e.g. in combination with L1/L2 ID of the source TX UE and observed pattern density over short time). A sidelink resource allocation pattern may be associated with one transmission of a TX-UE (i.e. with a specific destination ID). If a TX-UE performs two different sidelink transmissions, for example to RX-UE1 and RX-UE2, the TX-UE may use two different patterns/resource allocations.

In the present disclosure, a “short” time for observation of a pattern may be a time period between a few symbols and a maximum of a few slots. A “short” time may be a time between UE-A wake up time to and observed modified PSFCH (that carries the future sidelink resource allocation in the PID)”. Compared to sensing (at least 100 ms) or inter-UE-coordination (˜25 ms), a technical effect of an example embodiment of the present disclosure may be to enable a observation/monitoring period that is at least 1 order of magnitude shorter.

In an example embodiment, the UE may identify the pattern by monitoring a modified SCI. For example, a modified SCI may contain PID or part of the PID (it may be noted that the number of reserved bits in 1st stage SCI is 4).

Additionally or alternatively, the UE may identify the pattern by monitoring a modified PSFCH. For example, a modified PSFCH may contain PID or part of the PID. It may be noted that monitoring a modified PSFCH may be relevant/useful if the time instance to (260) is such that the UE-A (230) has missed the SCI. In other words, if to is after transmission/reception of 1st stage SCI, the UE may be able to detect PSFCH before SCI is transmitted again.

In an example embodiment, the modified PSFCH may indicate, for example with a 1 bit flag, whether the associated transmission was carried out based on a periodic/repetitive resource allocation pattern. In other words, one value of the flag may indicate that the transmission was not carried out based on a pattern (i.e. that the transmission was carried out as a single/unconnected/one-off occurrence), while another value of the flag may indicate that the transmission was carried out based on a pattern. In an example embodiment, this flag may be implemented by suitably offsetting the (N)ACK sequences. Several offsets of (N)ACK sequences are reserved (i.e. without current use), and thus may be dedicated to indicating simple auxiliary information. For example, a selected offset may indicate either resource allocation based on periodic pattern, or even a specific pattern in some predefined list. By determining the flag value, the monitoring UE (e.g. UE-A (230)) may identify re-occurring sidelink transmissions to be carried out in future (i.e. distinguish them from one-off transmissions) and take this information into account when allocating sidelink resources for its own future transmission.

In an example embodiment, as the flag may not directly reveal/indicate the PID to the monitoring UE, the UE may sense the pattern until a repetition is observed (i.e. for the duration of the pattern period). If the pattern is somewhat structured, its nature may be reliably estimated even from an observation lasting only a portion of the pattern period. In other words, the flag may trigger the UE to monitor for a (pre-defined) transmission pattern over the course of a (pre-defined) time period. In an example embodiment, the pattern may be derived dynamically by the source/transmitting UE. In other words, the TX-UE may dynamically (re) select the pattern based on, for example, the destination L1/L2 ID, based on a geographical area (e.g. sidelink zone ID), after a certain timer has expired (e.g. max_time_per_pattern); it may be up to the TX-UE to select from a pool of pre-defined patterns after a certain event occurs. To assist monitoring UEs, additional flags such as “pattern change”, “period”, “min/max duration” etc. may be envisaged/signaled.

In an example embodiment, the UE-A may avoid interference by controlling overlap between resources for future transmission(s) and resources already in use (e.g. control to produce zero or bounded probability of overlap). In an example embodiment, excessive resource overlaps (e.g. when collisions exceed tolerance threshold) may be resolved by/according to pre-defined measures for resource reservation release (e.g. back-off probability derived from the duration of successful resource allocation/UE identifiers such as L1/L2 ID/traffic priority/random value), and/or re-allocation (e.g. selection of a pattern with a new PID, or selection of the next eligible pattern in a pre-defined ordered set of resource allocation patterns characterized by one PID).

In an example embodiment, a seed may be used to determine a pseudo random time-frequency resource pattern in sidelink, uniquely per each TX UE transmission. The seed values used among multiple (neighboring) TX UEs may be chosen in such a way that all TX UEs using different UE unique seeds may have orthogonal time-frequency resource patterns. The chosen seed may be based on the TX-UE's: subscription identifier (SUPI), subscription concealed identifier (SUCI), L1/L2 ID or parts thereof, etc. In an alternative example embodiment, the seeds may be preconfigured to the UEs. Alternatively, there may be pattern overlap, with bounded overlap, between the seed values used among multiple (neighboring) TX UEs.

In an example embodiment, each TX UE in sidelink mode 2 may signal its applied/used seed (or pool of seeds) to its peer RX UE(s) (e.g. within the modified SCI). The RX UE(s) (e.g. UE-1 (215) and/or UE-2 (225)) may repeat the corresponding seed associated with the corresponding sidelink transmission in the modified PSFCH, thereby revealing the PID to nearby monitoring UEs (e.g. UE-A (230)). A newly activated UE (UE-A (230)) may thus determine, from monitoring TX UE's modified SCI and/or monitoring RX UE's modified PSFCH resources, the applied seeds of its neighboring TX UE(s), and may thereby determine the future resource pattern(s) of the monitored peer UE(s).

In an example embodiment, the monitoring of the modified PSFCH (which may contain information about the applied seeds) may allow the newly activated UE (e.g. UE-A (230)) to instantaneously (e.g. quickly, immediately, substantially at the time the modified PSFCH has been received by UE-A (230)) reconstruct the sidelink resource pattern of the past as well as future time-frequency allocations of its neighboring sidelink UEs.

In an example embodiment, the newly activated UE (e.g. UE-A (230)) may select either an unused seed or, alternatively, select those time-frequency resources that are not indicated for usage (i.e. occupied resources) by neighboring sidelink UEs (i.e. the residual sidelink resources). In other words, the newly activated UE may select one or more resources unoccupied by neighboring sidelink UEs.

In an example embodiment, a seed may be applied to determine the time-frequency sidelink resource allocation (pattern granularity of n frequency subchannels and m time slots) in sidelink mode 2 for a sidelink UE in a static manner. For example, a UE may be associated with a fixed seed (and hence a fixed time-frequency resource pattern). The mapping of a seed to a TX UE may be based on L2 ID, or a subset of the L2 ID of the UE. Any other UE specific identifier, such as L1-ID, SL-RNTI, SL-CS-RNTI, SUPI/SUCI, or parts thereof, may be used for direct mapping between UE and seed. In other words, a combination of the L2 ID, or a portion of the L2 ID, and one of L1-ID, SL-RNTI, SL-CS-RNTI, or SUPI/SUCI may be used to determine the seed used by the UE.

In an example embodiment, each UE may be preconfigured with a seed or pool of seeds. Alternatively, the V2X layer may hold a set/reservoir of seeds that may be configured, uniquely, to a UE, once the UE is under coverage (i.e. sidelink mode 1).

In an example embodiment, when a sidelink UE is in sidelink resource allocation mode 2, it may apply a seed per sidelink source/destination pair (i.e. per sidelink logical connection). The SL TX UE may signal a selected seed to its destination RX UE(s) in a modified SCI.

In an example embodiment, the intended RX UE(s) that have been informed about the applied seed of the SL TX UE may embed the seed information into the modified PSFCH resources.

In an example embodiment, the unused PSFCH resource s) associated transmission (e.g. over-dimensioned PSFCH with a PSSCH resource(s)) may carry information about the applied seed used for the associated PSSCH transmission. The information about the applied seed may be composed of (but not limited to): seed sequence itself; a subsequence of the seed (e.g. n LSB of the seed); a seed ID uniquely associated with the seed; ID associated with a pool of seeds; and/or ID associated with the entries of a seed codebook (note: the entries may have the same dimension as the codebook, e.g. one-dimensional or two-dimensional).

In another example embodiment, the RX UE may use orthogonal resources on top of the standard PSFCH resources to carry information about the applied seed for the sidelink transmission. For example, the information about the seed may be carried by a sequence that is orthogonal to the standard PSFCH sequence.

In an example embodiment, in contrast to indicating the applied seed, the RX UE may alternatively indicate the remaining/unused seeds to inform a newly activated UE directly about available seeds. The information about the unused/remaining seed(s) may consist of: list of free/available seeds; list of subsequences of free seeds (e.g. n LSB of each free seed); a seed ID uniquely associated with the seed; ID associated with a pool of seeds; and/or ID associated with the entries of a seed codebook (note: the entries may have the same dimension as the codebook, e.g. one-dimensional or two-dimensional).

The newly activated UE (e.g. UE-A (230)) may monitor the modified PSFCH feedback and may be informed about the applied (alternatively informed about the unused) seeds.

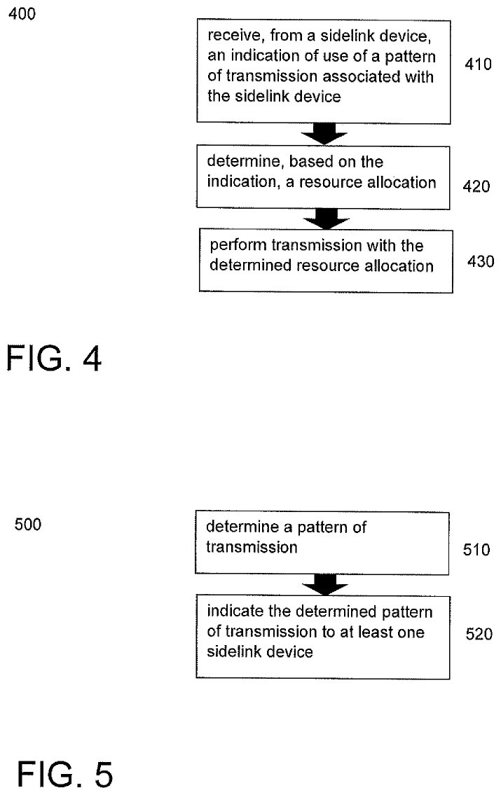

FIG. 4 illustrates the potential steps of an example method 400. The example method 400 may include: receiving, from a sidelink device, an indication of use of a pattern of transmission associated with the sidelink device, 410; determining, based on the indication, a resource allocation, 420; and performing transmission with the determined resource allocation, 430. The resource allocation may be a resource allocation for a device performing the example method 400. The device may be configured to perform sidelink communication.

FIG. 5 illustrates the potential steps of an example method 500. The example method 500 may include: determining a pattern of transmission, and indicating the determined pattern of transmission to at least one sidelink device, 520. The pattern of transmission may be associated with a device performing the example method 500. The device may be configured to perform sidelink communication.

In accordance with one example embodiment, an apparatus may comprise: at least one processor; and at least one memory including computer program code; the at least one memory and the computer program code configured to, with the at least one processor, cause the apparatus at least to: receive, from a sidelink device, an indication of use of a pattern of transmission associated with the sidelink device; determine, based on the indication, a resource allocation for the apparatus; and perform transmission with the determined resource allocation.

The indication of use of the pattern of transmission associated with the sidelink device may comprise at least one of: a flag configured to indicate the use of the pattern of transmission, or a pattern identifier associated with the pattern of transmission.

The pattern identifier may comprise at least one of: a pattern configuration parameter, or a hash value associated with the pattern configuration parameter.

The example apparatus may be further configured to: receive a pattern configuration parameter, wherein determining the resource allocation may be based, at least partially, on the pattern configuration parameter.

The pattern configuration parameter may comprise at least one of: an identifier of the sidelink device, a seed value associated with the pattern of transmission, an offset value associated with the pattern of transmission, a periodicity associated with the pattern of transmission, an indication of at least one available seed, a sub-sequence of an available seed, an identifier associated with an available seed, an identifier associated with a pool of available seeds, or an identifier associated with at least one entry of a seed codebook.

The seed value associated with the pattern of transmission may comprise at least one of: a sequence of a seed associated with the pattern of transmission, a sub-sequence of the seed associated with the pattern of transmission, an identifier of the seed associated with the pattern of transmission, an identifier associated with a pool of seed values associated with the pattern of transmission, or an identifier associated with at least one entry of a further seed codebook.

Receiving the indication may comprises the example apparatus being further configured to receive at least one of: a physical sidelink feedback channel message including the indication, a sidelink control information message including the indication, or a system information block including the indication.

Determining the resource allocation may comprise the example apparatus being further configured to: perform monitoring of the sidelink device; and determine the pattern of transmission based on the performed monitoring.

Determining the resource allocation may comprise the example apparatus being further configured to: control overlap between the resource allocation and resources associated with the pattern of transmission associated with the sidelink device.

Determining the resource allocation may comprise the example apparatus being further configured to: determine a time-frequency resource pattern orthogonal to the pattern of transmission associated with the sidelink device.

The determined time-frequency resource pattern may be determined from a pre-configured set of time-frequency resource patterns.

The determined time-frequency resource pattern may be determined based, at least partially, on at least one of: a subscription identifier of the apparatus, a part of the subscription identifier of the apparatus, a subscription concealed identifier of the apparatus, a part of the subscription concealed identifier of the apparatus, a layer one or layer two identifier of the apparatus, or a part of the layer one or layer two identifier of the apparatus.

The determined resource allocation may comprise one or more resources not associated with the pattern of transmission associated with the sidelink device.

In accordance with one aspect, an example method may be provided comprising: receiving, with a first device from a sidelink device, an indication of use of a pattern of transmission associated with the sidelink device; determining, based on the indication, a resource allocation for the first device; and performing transmission with the determined resource allocation.

The indication of use of the pattern of transmission associated with the sidelink device may comprise at least one of: a flag configured to indicate the use of the pattern of transmission, or a pattern identifier associated with the pattern of transmission.

The pattern identifier may comprise at least one of: a pattern configuration parameter, or a hash value associated with the pattern configuration parameter.

The example method may further comprise: receiving a pattern configuration parameter, wherein determining the resource allocation may be based, at least partially, on the pattern configuration parameter.

The pattern configuration parameter may comprise at least one of: an identifier of the sidelink device, a seed value associated with the pattern of transmission, an offset value associated with the pattern of transmission, a periodicity associated with the pattern of transmission, an indication of at least one available seed, a sub-sequence of an available seed, an identifier associated with an available seed, an identifier associated with a pool of available seeds, or an identifier associated with at least one entry of a seed codebook.

The seed value associated with the pattern of transmission may comprise at least one of: a sequence of a seed associated with the pattern of transmission, a sub-sequence of the seed associated with the pattern of transmission, an identifier of the seed associated with the pattern of transmission, an identifier associated with a pool of seed values associated with the pattern of transmission, or an identifier associated with at least one entry of a further seed codebook.

The receiving of the indication may further comprise receiving at least one physical sidelink feedback channel message including the indication, a sidelink control information message including the indication, or a system information block including the indication.

The determining of the resource allocation may comprise: performing monitoring of the sidelink device; and determining the pattern of transmission based on the performed monitoring.

The determining of the resource allocation may comprise: controlling overlap between the resource allocation and resources associated with the pattern of transmission associated with the sidelink device.

The determining of the resource allocation may comprise: determining a time-frequency resource pattern orthogonal to the pattern of transmission associated with the sidelink device.

The determined time-frequency resource pattern may be determined from a pre-configured set of time-frequency resource patterns.

The determined time-frequency resource pattern may be determined based, at least partially, on at least one of: a subscription identifier of the first device, a part of the subscription identifier of the first device, a subscription concealed identifier of the first device, a part of the subscription concealed identifier of the first device, a layer one or layer two identifier of the first device, or a part of the layer one or layer two identifier of the first device.

The determined resource allocation may comprise one or more resources not associated with the pattern of transmission associated with the sidelink device.

In accordance with one example embodiment, an apparatus may comprise: circuitry configured to perform: receive, from a sidelink device, an indication of use of a pattern of transmission associated with the sidelink device; determine, based on the indication, a resource allocation for the apparatus; and transmit with the determined resource allocation.

In accordance with one example embodiment, an apparatus may circuitry including comprise: processing circuitry; memory computer program code, the memory circuitry and the computer program code configured to, with the processing circuitry, enable the apparatus to: receive, from a sidelink device, an indication of use of a pattern of transmission associated with the sidelink device; determine, based on the indication, a resource allocation for the apparatus; and perform transmission with the determined resource allocation.

As used in this application, the term “circuitry” may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g. firmware) for operation, but the software may not be present when it is not needed for operation.” This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

In accordance with one example embodiment, an apparatus may comprise means for performing: receiving, from a sidelink device, an indication of use of a pattern of transmission associated with the sidelink device; determining, based on the indication, a resource allocation for the apparatus; and performing transmission with the determined resource allocation.

The indication of use of the pattern of transmission associated with the sidelink device may comprise at least one of: a flag configured to indicate the use of the pattern of transmission, or a pattern identifier associated with the pattern of transmission.

The pattern identifier may comprise at least one of: a pattern configuration parameter, or a hash value associated with the pattern configuration parameter.

The means may be further configured to perform: receiving a pattern configuration parameter, wherein determining the resource allocation may be based, at least partially, on the pattern configuration parameter.

The pattern configuration parameter may comprise at least one of: an identifier of the sidelink device, a seed value associated with the pattern of transmission, an offset value associated with the pattern of transmission, a periodicity associated with the pattern of transmission, an indication of at least one available seed, a sub-sequence of an available seed, an identifier associated with an available seed, an identifier associated with a pool of available seeds, or an identifier associated with at least one entry of a seed codebook.

The seed value associated with the pattern of transmission may comprise at least one of: a sequence of a seed associated with the pattern of transmission, a sub-sequence of the seed associated with the pattern of transmission, an identifier of the seed associated with the pattern of transmission, an identifier associated with a pool of seed values associated with the pattern of transmission, or an identifier associated with at least one entry of a further seed codebook.

The means configured to perform receiving of the indication may further comprise means configured to perform receiving at least one of: a physical sidelink feedback channel message including the indication, a sidelink control information message including the indication, or a system information block including the indication.

The means configured to perform determining of the resource allocation may comprise means to perform: performing monitoring of the sidelink device; and determining the pattern of transmission based on the performed monitoring.

The means configured to perform determining of the resource allocation may comprise means configured to perform: controlling overlap between the resource allocation and resources associated with the pattern of transmission associated with the sidelink device.

The means configured to perform determining of the resource allocation may comprise means configured to perform: determining a time-frequency resource pattern orthogonal to the pattern of transmission associated with the sidelink device.

The determined time-frequency resource pattern may be determined from a pre-configured set of time-frequency resource patterns.

The determined time-frequency resource pattern may be determined based, at least partially, on at least one of: a subscription identifier of the apparatus, a part of the subscription identifier of the apparatus, a subscription concealed identifier of the apparatus, a part of the subscription concealed identifier of the apparatus, a layer one or layer two identifier of the apparatus, or a part of the layer one or layer two identifier of the apparatus.

The determined resource allocation may comprise one or more resources not associated with the pattern of transmission associated with the sidelink device.

In accordance with one example embodiment, a non-transitory computer-readable medium comprising program instructions stored thereon which, when executed with at least one processor, cause the at least one processor to: receive, with a first device from a sidelink device, an indication of use of a pattern of transmission associated with the sidelink device; determine, based on the indication, a resource allocation for the first device; and perform transmission with the determined resource allocation.

The indication of use of the pattern of transmission associated with the sidelink device may comprise at least one of: a flag configured to indicate the use of the pattern of transmission, or a pattern identifier associated with the pattern of transmission.

The pattern identifier may comprise at least one of: a pattern configuration parameter, or a hash value associated with the pattern configuration parameter.

The example non-transitory computer-readable medium may be further configured to: receive a pattern configuration parameter, wherein determining the resource allocation may be based, at least partially, on the pattern configuration parameter.

The pattern configuration parameter may comprise at least one of: an identifier of the sidelink device, a seed value associated with the pattern of transmission, an offset value associated with the pattern of transmission, a periodicity associated with the pattern of transmission, an indication of at least one available seed, a sub-sequence of an available seed, an identifier associated with an available seed, an identifier associated with a pool of available seeds, or an identifier associated with at least one entry of a seed codebook.

The seed value associated with the pattern of transmission may comprise at least one of: a sequence of a seed associated with the pattern of transmission, a sub-sequence of the seed associated with the pattern of transmission, an identifier of the seed associated with the pattern of transmission, an identifier associated with a pool of seed values associated with the pattern of transmission, or an identifier associated with at least one entry of a further seed codebook.

Receiving the indication may comprise the example non-transitory computer-readable medium being further configured to receive at least one of: a physical sidelink feedback channel message including the indication, a sidelink control information message including the indication, or a system information block including the indication.

Determining the resource allocation may comprise the example non-transitory computer-readable medium being further configured to: perform monitoring of the sidelink device; and determine the pattern of transmission based on the performed monitoring. Determining the resource allocation may comprise the example non-transitory computer-readable medium being further configured to: control overlap between the resource allocation and resources associated with the pattern of transmission associated with the sidelink device.

Determining the resource allocation may comprise the example non-transitory computer-readable medium being further configured to: determine a time-frequency resource pattern orthogonal to the pattern of transmission associated with the sidelink device.

The determined time-frequency resource pattern may be determined from a pre-configured set of time-frequency resource patterns.

The determined time-frequency resource pattern may be determined based, at least partially, on at least one of: a subscription identifier of the first device, a part of the subscription identifier of the first device, a subscription concealed identifier of the first device, a part of the subscription concealed identifier of the first device, a layer one or layer two identifier of the first device, or a part of the layer one or layer two identifier of the first device.

The determined resource allocation may comprise one or more resources not associated with the pattern of transmission associated with the sidelink device.

In accordance with another example embodiment, a non-transitory program storage device readable by a machine may be provided, tangibly embodying a program of instructions executable by the machine for performing operations, the operations comprising: receive, with a first device from a sidelink device, an indication of use of a pattern of transmission associated with the sidelink device; determine, based on the indication, a resource allocation for the first device; and perform transmission with the determined resource allocation.

In accordance with one example embodiment, an apparatus may comprise: at least one processor; and at least one memory including computer program code; the at least one memory and the computer program code configured to, with the at least one processor, cause the apparatus at least to: determine a pattern of transmission associated with the apparatus; and indicate the determined pattern of transmission to at least one sidelink device.

Indicating the determined pattern of transmission may comprise indicating at least one of: a flag configured to indicate use of the pattern of transmission, or a pattern identifier associated with the determined pattern of transmission.

The pattern identifier may comprise at least one of: a pattern configuration parameter, or a hash value associated with the pattern configuration parameter.

The example apparatus may be further configured to: transmit a pattern configuration parameter to the at least one sidelink device.

The pattern configuration parameter may comprise at least one of: an identifier of the apparatus, a seed value associated with the pattern of transmission, an offset value associated with the pattern of transmission, a periodicity associated with the pattern of transmission, an indication of at least one available seed, a sub-sequence of an available seed, an identifier associated with an available seed, an identifier associated with a pool of available seeds, or an identifier associated with at least one entry of a seed codebook.

The seed value associated with the pattern of transmission may comprise at least one of: a sequence of a seed associated with the pattern of transmission, a sub-sequence of the seed associated with the pattern of transmission, an identifier of the seed associated with the pattern of transmission, an identifier associated with a pool of seed values associated with the pattern of transmission, or an identifier associated with at least one entry of a further seed codebook.

The determined pattern of transmission may be indicated via at least one of: a physical sidelink feedback channel message, a sidelink control information message, or a system information block.

The pattern of transmission may be determined from a pre-configured set of time-frequency resource patterns.

The pattern of transmission may be determined based, at least partially, on at least one of: a subscription identifier of the apparatus, a part of the subscription identifier of the apparatus, a subscription concealed identifier of the apparatus, a part of the subscription concealed identifier of the apparatus, a layer one or layer two identifier of the apparatus, or a part of the layer one or layer two identifier of the apparatus.

In accordance with one aspect, an example method may be provided comprising: determining a pattern of transmission associated with a first device; and indicating the determined pattern of transmission to at least one sidelink device.

The indicating of the determined pattern of transmission may comprise indicating at least one of: a flag configured to indicate use of the pattern of transmission, or a pattern identifier associated with the determined pattern of transmission.

The pattern identifier may comprise at least one of: a pattern configuration parameter, or a hash value associated with the pattern configuration parameter.

The example method may further comprise: transmitting a pattern configuration parameter to the at least one sidelink device.

The pattern configuration parameter may comprise at least one of: an identifier of the first device, a seed value associated with the pattern of transmission, an offset value associated with the pattern of transmission, a periodicity associated with the pattern of transmission, an indication of at least one available seed, a sub-sequence of an available seed, an identifier associated with an available seed, an identifier associated with a pool of available seeds, or an identifier associated with at least one entry of a seed codebook.

The seed value associated with the pattern of transmission may comprise at least one of: a sequence of a seed associated with the pattern of transmission, a sub-sequence of the seed associated with the pattern of transmission, an identifier of the seed associated with the pattern of transmission, an identifier associated with a pool of seed values associated with the pattern of transmission, or an identifier associated with at least one entry of a further seed codebook.

The determined pattern of transmission may be indicated via at least one of: a physical sidelink feedback channel message, a sidelink control information message, or a system information block.

The pattern of transmission may be determined from a pre-configured set of time-frequency resource patterns.

The pattern of transmission may be determined based, at least partially, on at least one of: a subscription identifier of the first device, a part of the subscription identifier of the first device, a subscription concealed identifier of the first device, a part of the subscription concealed identifier of the first device, a layer one or layer two identifier of the first device, or a part of the layer one or layer two identifier of the first device.

In accordance with one example embodiment, an apparatus may comprise: circuitry configured to perform: determine a pattern of transmission associated with the apparatus; and indicate the determined pattern of transmission to at least one sidelink device.

In accordance with one example embodiment, an apparatus may comprise: processing circuitry; memory circuitry including computer program code, the memory circuitry and the computer program code configured to, with the processing circuitry, enable the apparatus to: determine a pattern of transmission associated with the apparatus; and indicate the determined pattern of transmission to at least one sidelink device.

In accordance with one example embodiment, an apparatus may comprise means for performing: determining a pattern of transmission associated with the apparatus; and indicating the determined pattern of transmission to at least one sidelink device. The means configured to perform indicating of the determined pattern of transmission may comprise means configured to perform indicating at least one of: a flag configured to indicate use of the pattern of transmission, or a pattern identifier associated with the determined pattern of transmission.

The pattern identifier may comprise at least one of: a pattern configuration parameter, or a hash value associated with the pattern configuration parameter.

The means may be further configured to perform: transmitting a pattern configuration parameter to the at least one sidelink device.

The pattern configuration parameter may comprise at least one of: an identifier of the apparatus, a seed value associated with the pattern of transmission, an offset value associated with the pattern of transmission, a periodicity associated with the pattern of transmission, an indication of at least one available seed, a sub-sequence of an available seed, an identifier associated with an available seed, an identifier associated with a pool of available seeds, or an identifier associated with at least one entry of a seed codebook.

The seed value associated with the pattern of transmission may comprise at least one of: a sequence of a seed associated with the pattern of transmission, a sub-sequence of the seed associated with the pattern of transmission, an identifier of the seed associated with the pattern of transmission, an identifier associated with a pool of seed values associated with the pattern of transmission, or an identifier associated with at least one entry of a further seed codebook.

The determined pattern of transmission may be indicated via at least one of: a physical sidelink feedback channel message, a sidelink control information message, or a system information block.

The pattern of transmission may be determined from a pre-configured set of time-frequency resource patterns.

The pattern of transmission may be determined based, at least partially, on at least one of: a subscription identifier of the apparatus, a part of the subscription identifier of the apparatus, a subscription concealed identifier of the apparatus, a part of the subscription concealed identifier of the apparatus, a layer one or layer two identifier of the apparatus, or a part of the layer one or layer two identifier of the apparatus.

In accordance with one example embodiment, a non-transitory computer-readable medium comprising program instructions stored thereon which, when executed with at least one processor, cause the at least one processor to: determine a pattern of transmission associated with a first device; and indicate the determined pattern of transmission to at least one sidelink device.

Indicating the determined pattern of transmission may comprise indicating at least one of: a flag configured to indicate use of the pattern of transmission, or a pattern identifier associated with the determined pattern of transmission.

The pattern identifier may comprise at least one of: a pattern configuration parameter, or a hash value associated with the pattern configuration parameter.

The example non-transitory computer-readable medium may be further configured to: transmit a pattern configuration parameter to the at least one sidelink device.

The pattern configuration parameter may comprise at least one of: an identifier of the first device, a seed value associated with the pattern of transmission, an offset value associated with the pattern of transmission, a periodicity associated with the pattern of transmission, an indication of at least one available seed, a sub-sequence of an available seed, an identifier associated with an available seed, an identifier associated with a pool of available seeds, or an identifier associated with at least one entry of a seed codebook.

The seed value associated with the pattern of transmission may comprise at least one of: a sequence of a seed associated with the pattern of transmission, a sub-sequence of the seed associated with the pattern of transmission, an identifier of the seed associated with the pattern of transmission, an identifier associated with a pool of seed values associated with the pattern of transmission, or an identifier associated with at least one entry of a further seed codebook.

The determined pattern of transmission may be indicated via at least one of: a physical sidelink feedback channel message, a sidelink control information message, or a system information block.

The pattern of transmission may be determined from a pre-configured set of time-frequency resource patterns.

The pattern of transmission may be determined based, at least partially, on at least one of: a subscription identifier of the first device, a part of the subscription identifier of the first device, a subscription concealed identifier of the first device, a part of the subscription concealed identifier of the first device, a layer one or layer two identifier of the first device, or a part of the layer one or layer two identifier of the first device.

In accordance with another example embodiment, a non-transitory program storage device readable by a machine may be provided, tangibly embodying a program of instructions executable by the machine for performing operations, the operations comprising: determine a pattern of transmission associated with a first device; and indicate the determined pattern of transmission to at least one sidelink device.

In accordance with another example embodiment, a computer program comprising instructions stored thereon for performing at least the following: receiving, with a first device from a sidelink device, an indication of use of a pattern of transmission associated with the sidelink device; determining, based on the indication, a resource allocation for the first device; and performing transmission with the determined resource allocation.

In accordance with another example embodiment, a computer program comprising instructions stored thereon for performing at least the following: determining a pattern of transmission associated with a first device; and indicating the determined pattern of transmission to at least one sidelink device.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modification and variances which fall within the scope of the appended claims.

1-49. (canceled)

50. An apparatus comprising:
at least one processor; and
at least one non-transitory memory including computer program code;
the at least one memory and the computer program code configured to, with the at least one processor, cause the apparatus at least to:
receive, from a sidelink device, an indication of use of a pattern of transmission associated with the sidelink device;
determine, based on the indication, a resource allocation for the apparatus; and
perform transmission with the determined resource allocation.

51. The apparatus of claim 50, wherein the indication of use of the pattern of transmission associated with the sidelink device comprises at least one of:
a flag configured to indicate the use of the pattern of transmission, or
a pattern identifier associated with the pattern of transmission.

52. The apparatus of claim 51, wherein the pattern identifier comprises at least one of:
a pattern configuration parameter, or
a hash value associated with the pattern configuration parameter.

53. The apparatus of claim 52, wherein the pattern configuration parameter comprises at least one of:
an identifier of the sidelink device,
a seed value associated with the pattern of transmission,
an offset value associated with the pattern of transmission,
a periodicity associated with the pattern of transmission,
an indication of at least one available seed,
a sub-sequence of an available seed,
an identifier associated with an available seed,
an identifier associated with a pool of available seeds, or
an identifier associated with at least one entry of a seed codebook.

54. The apparatus of claim 53, wherein the seed value associated with the pattern of transmission comprises at least one of:
a sequence of a seed associated with the pattern of transmission,
a sub-sequence of the seed associated with the pattern of transmission,
an identifier of the seed associated with the pattern of transmission,
an identifier associated with a pool of seed values associated with the pattern of transmission, or
an identifier associated with at least one entry of a further seed codebook.

55. The apparatus of claim 50, wherein the at least one memory and the computer program code are configured to, with the at least one processor, cause the apparatus to:
receive a pattern configuration parameter, wherein determining the resource allocation is based, at least partially, on the pattern configuration parameter.

56. The apparatus of claim 50, wherein receiving the indication comprises the at least one memory and the computer program code are configured to, with the at least one processor, cause the apparatus to receive at least one of:
a physical sidelink feedback channel message including the indication,
a sidelink control information message including the indication, or
a system information block including the indication.

57. The apparatus of claim 50, wherein determining the resource allocation comprises the at least one memory and the computer program code are configured to, with the at least one processor, cause the apparatus to:
perform monitoring of the sidelink device; and
determine the pattern of transmission based on the performed monitoring.

58. The apparatus of claim 50, wherein determining the resource allocation comprises the at least one memory and the computer program code are configured to, with the at least one processor, cause the apparatus to:
control overlap between the resource allocation and resources associated with the pattern of transmission associated with the sidelink device.

59. The apparatus of claim 50, wherein determining the resource allocation comprises the at least one memory and the computer program code are configured to, with the at least one processor, cause the apparatus to:
determine a time-frequency resource pattern orthogonal to the pattern of transmission associated with the sidelink device.

60. The apparatus of claim 59, wherein the determined time-frequency resource pattern is determined from a pre-configured set of time-frequency resource patterns.

61. The apparatus of claim 59, wherein the determined time-frequency resource pattern is determined based, at least partially, on at least one of:
a subscription identifier of the apparatus,
a part of the subscription identifier of the apparatus,
a subscription concealed identifier of the apparatus,
a part of the subscription concealed identifier of the apparatus,
a layer one or layer two identifier of the apparatus, or
a part of the layer one or layer two identifier of the apparatus.

62. The apparatus of claim 50, wherein the determined resource allocation comprises one or more resources not associated with the pattern of transmission associated with the sidelink device.

63. A method comprising:
receiving, with a first device from a sidelink device, an indication of use of a pattern of transmission associated with the sidelink device;
determining, based on the indication, a resource allocation for the first device; and
performing transmission with the determined resource allocation.

64. An apparatus comprising:
at least one processor; and
at least one non-transitory memory including computer program code;
the at least one memory and the computer program code configured to, with the at least one processor, cause the apparatus at least to:
determine a pattern of transmission associated with the apparatus; and
indicate the determined pattern of transmission to at least one sidelink device.

65. The apparatus of claim 64, wherein indicating the determined pattern of transmission comprises indicating at least one of:
a flag configured to indicate use of the pattern of transmission, or
a pattern identifier associated with the determined pattern of transmission.

66. The apparatus of claim 65, wherein the pattern identifier comprises at least one of:
a pattern configuration parameter, or
a hash value associated with the pattern configuration parameter.

67. The apparatus of claim 66, wherein the pattern configuration parameter comprises at least one of:
an identifier of the apparatus,
a seed value associated with the pattern of transmission,
an offset value associated with the pattern of transmission,
a periodicity associated with the pattern of transmission,
an indication of at least one available seed,
a sub-sequence of an available seed,
an identifier associated with an available seed,
an identifier associated with a pool of available seeds, or
an identifier associated with at least one entry of a seed codebook.

68. The apparatus of claim 64, wherein the at least one memory and the computer program code are configured to, with the at least one processor, cause the apparatus to:
transmit a pattern configuration parameter to the at least one sidelink device.

69. The apparatus of claim 68, wherein the seed value associated with the pattern of transmission comprises at least one of:
a sequence of a seed associated with the pattern of transmission,
a sub-sequence of the seed associated with the pattern of transmission,
an identifier of the seed associated with the pattern of transmission,
an identifier associated with a pool of seed values associated with the pattern of transmission, or
an identifier associated with at least one entry of a further seed codebook.
